(19) United States
(12) Patent Application Publication
(10) Pub. No.: US 2006/0244969 A1
(43) Pub. Date: Nov. 2, 2006

(54) APPARATUS AND METHODS FOR SCATTEROMETRY OF OPTICAL DEVICES

(76) Inventors: Tom W. Ryan, Bend, OR (US); Chris Raymond, Bend, OR (US); Steven G. Hummel, Bend, OR (US)

Correspondence Address: PERKINS COIE LLP, POST OFFICE BOX 1208, SEATTLE, WA, 98111-1208, US

(21) Appl. No.: 11/279,075

(22) Filed: Apr. 7, 2006

Related U.S. Application Data
(60) Provisional application No. 60/669,787, filed on Apr. 7, 2005.

(51) Int. Cl. G01N 21/47

(52) U.S. Cl. 356/446

(57) ABSTRACT

In a method for measuring a dimension or angle of a scattering feature of an optical device, such as a photonic crystal, at least part of the array is irradiated with light. A characteristic of light scattered from the array is detected. A comparison algorithm is run on the detected characteristic of the scattered light. The comparison algorithm provides one or more numerical values indicative of the measured dimension or angle. A system for measuring a dimension or angle of a feature of an optical device includes a light source and optics for focusing light from the light source onto a target area of the optical device. A light detector is positioned to detect scattered light from the target area, with the detected light used to create a measured light characteristic. A computer linked to the light detector performs a comparison algorithm on the measured light characteristic and outputs a numerical value of the dimension or angle measured. In method for designing an optical device, such as a photonic crystal for use on an LED, an intended scattered response based on light emission characteristics desired from the optical device is simulated. One or more design parameters of the optical device are varied. An interim reflectance response of the optical device with variation of the parameters is determined. Interim scattered responses are compared to the intended scattered response. One or more scattered responses which match the intended scattered response are selected. An optical device is designed using one or more of the design parameters associated with the selected interim scattered response.

This Application claims priority to U.S. Provisional Patent Application No. 60/669,787 filed Apr. 7, 2005. The field of the invention is optical devices and measuring features of optical devices, such as photonic crystals and LEDs.

### TECHNICAL FIELD

### Background

Semiconductor devices, light emitting diodes (LEDs) and other optical or microelectronic devices are typically manufactured on a workpiece having a large number of individual dies (e.g., chips or devices). Each wafer undergoes several different procedures to construct the switches, capacitors, conductive interconnects, filters and other components of the device. For example, a workpiece can be processed using lithography, implanting, etching, deposition, planarization, annealing, and other procedures that are repeated to construct a high density of features. One aspect of manufacturing these devices is evaluating the workpieces to ensure that the microstructures are within the desired specifications.

Photonic crystals (PCs) are optical structures that may be used to improve the performance of a micro-optical device like an LED. A photonic crystal is a device that comprises an array of scattering features in some host medium, such as air cylinders which have been etched into some material like gallium nitride (GaN) or indium phosphide (InP). The scattering structures are usually small, typically less than 1 um in width. As light interacts with a photonic crystal, its propagation characteristics are altered. For this reason, the photonic crystal can also be thought of as a synthetic lens. When a photonic crystal structure is positioned above the emission region of an LED device, for example, the output efficiency of the LED increases while the directionality of the output light is improved. Hence, the use of a photonic crystal structure with an LED is desirable.

One challenge in manufacturing photonic crystals for use with LEDs is that the structure of the photonic crystal scattering features has a strong influence on the performance of the crystal itself. If the dimensions of the scattering features vary, the performance of the LED will not be precise since it will vary from workpiece to workpiece. Furthermore, if the shape or position of the scattering features is not optimal, the performance of the LED will also be less than optimal. For these reasons, characterization or metrology of the photonic crystal is important for LED device performance.

Another challenge in the manufacture of photonic crystal for use with LEDs is alignment of the photonic crystal with the LED emission region. In some case, the photonic crystal layer can be manufactured directly above the LED emission region of the workpiece. In other manufacturing processes, the photonic crystal may be manufactured on a separate workpiece and bonded to the LED. In either instance, the photonic crystal must be well aligned with the LED emission region for the LED to perform optimally and reliably.

Scatterometry is a technology for evaluating several parameters of microstructures and may be useful in the measurement of photonic crystal structures. With respect to semiconductor devices, scatterometry is used to evaluate film thickness, line spacing, trench depth, trench width, and other aspects of microstructures. Many semiconductor wafers, for example, include scatterometry targets in the scribe lines between the individual dies to provide a scattering structure that can be evaluated using existing scatterometry equipment. One existing scatterometry process includes illuminating such scattering structures on a workpiece and obtaining a representation of the scattered radiation returning from the periodic structure. The representation of return radiation is then analyzed to estimate one or more parameters of the microstructure.

One challenge of scatterometry for the measurement of photonic crystal structures is properly locating the small scattering structures on the workpiece. Because these structures are considered a part of the device itself and not a test structure in the scribe line, the scatterometry measurement system must include a navigation system for properly positioning over the measurement area. Moreover, the spot size of the scatterometer must be appropriate for the array of features being measured. Ideally, the spot size should illuminate most of but not overfill the array of features. Because LED devices are made with different sizes of emission areas, the spot size used to measure PCs may be variable. For measurements on one LED/PC device, it may need to be small, i.e., ten microns while for measurements on another LED/PC device, it might be large, i.e., several hundred microns. This is in contrast to typical semiconductor applications, where the spot size is generally chosen to be as small as possible in order to minimize target area in the scribe line.

Another challenge of using scatterometry to evaluate PC structures is obtaining a useful representation of the radiation returning from such microstructures. Because the PC structures are typically more complicated than semiconductor structures, the returning radiation pattern may be complex. PC structures will scatter light in all angular directions, so a scatterometry measurement system that can measure in all angular directions would be advantageous for measuring PC structures. This is in contrast to semiconductor applications, where most scatterometry targets are two-dimensional line-space structures that scatter light in one plane only. Hence, a scatterometer that measures returning radiation in one plane only is sufficient for semiconductor applications, but may be inadequate for the measurement of PC structures.

Another challenge of assessing PC structures using scatterometry relates to the optical properties of the materials that are used to manufacture such structures. For typical semiconductor applications, the workpiece substrate and other layers is silicon, which is typically absorbing for illumination at optical energies greater than the bandgap of the material. For PC-LED applications, the workpiece substrates and other layers can be materials like indium phosphide (InP) or gallium arsenide (GaAs), which have different bandgaps and are therefore absorbing at different wavelengths. A typical GaN LED might be made using a wide bandgap material such as sapphire or other oxide or dielectric. These materials become absorbing at extremely short wavelengths that are not typically employed in optical metrology systems. The fact that a PC-LED substrate is non-absorbing creates difficulties in managing back-reflections from the back-side of the substrate and other layers. In contrast to semiconductor applications, where there is no back-side reflection because all the radiation is absorbed, back-reflections for PC-LED applications can interfere with the incident illumination and therefore alter the returning or scattered radiation. For this reason, back-reflections in a photonic crystal scatterometry measurement must be eliminated or accounted for in the measurement process.

### BRIEF DESCRIPTION OF THE DRAWINGS

FIG. 1 is a schematic view illustrating a scatterometer in accordance with an embodiment of the invention.

FIG. 2 is a schematic isometric view illustrating a portion of a three-dimensional convergence beam for irradiating microstructures on a workpiece in accordance with an embodiment of the invention.

FIG. 3 is a schematic view illustrating an optical system for use in a scatterometer in accordance with an embodiment of the invention.

FIG. 4 is a schematic view illustrating an optical system and an auto-focus system for use in a scatterometer in accordance with an embodiment of the invention.

FIG. 5A is a simulated intensity distribution for use in a scatterometer in accordance with an embodiment of the invention.

FIG. 5B is a measured intensity distribution provide by a scatterometer in accordance with an embodiment of the invention.

FIG. 6 is a schematic view illustrating a portion of a computer system and a computational method for ascertaining parameters of photonic crystal microstructures using a scatterometer in accordance with an embodiment of the invention.

FIG. 7 is a perspective representation of a photonic crystal on an LED.

FIG. 8 is a schematic view showing target dimensions.

FIG. 9 is schematic view of doubly periodic structure.

FIGS. 10A, B, and C show measurement sensitivity to change with feature spacing S as the critical dimension. FIG. 10A shows the critical dimension as the spacing between the features. FIG. 10B is a plot of the actual data from the simulation taken with S as the critical dimension. FIG. 10C is a plot of the actual data from the simulation taken with S changed by 1% (3 nm).

FIGS. 11A, B, and C show measurement sensitivity to change with sidewall angle A as the critical dimension. FIG. 11A shows the critical dimension as the sidewall angle A. FIG. 11B is a plot of the actual data from the simulation taken with A as the critical dimension. FIG. 11C is a plot of the actual data from the simulation taken with A changed by 0.5°.

FIGS. 12A, B, and C show measurement sensitivity to change with feature height H as the critical dimension. FIG. 12A shows the critical dimension as the feature height. FIG. 12B is a plot of the actual data from the simulation taken with H as the critical dimension. FIG. 12C is a plot of the actual data from the measurement taken with H changed by 1% (2.5 nm).

FIGS. 13A, B, and C are drawings of square array layouts of round, oval or elliptical, and rectangular or square scatterometry features of a photonic crystal, for use with an LED.

FIGS. 14A, B, and C are drawings of rectangle array layouts of round, oval or elliptical, and rectangular or square scatterometry features of a photonic crystal, for use with an LED.

FIGS. 15A, B, and C are drawings of diamond/triangle array layouts of round, oval or elliptical, and rectangular or square scatterometry features of a photonic crystal, for use with an LED.

FIGS. 16A, B, and C are schematic drawings of hexagon array layouts of round, oval or elliptical, and rectangular or square scatterometry features of a photonic crystal, for use with an LED.

FIGS. 17 and 18 are diagrams of optimizing an array layout with varying shapes.

FIGS. 19A, B, C and D are profiles or section views of scatterometry features for use in a photonic crystal, for use with an LED.

FIG. 20 is a drawing of a photonic crystal design with the scattering features formed as posts or columns with an air filler.

FIG. 21 is a drawing of a photonic crystal design with the scattering features formed as air holes with an optical material filler.

FIG. 22 is an enlarged section view of a single scattering feature from the photonic crystal shown in FIG. 21, with an air hole surrounded by gallium nitride filler.

FIG. 23 is an enlarged section view of a single scattering feature formed from an oxide material with a gallium nitride filler, for use in a photonic crystal.

FIG. 24 is an enlarged section view of a single gallium nitride scattering feature and an oxide filler, for use in a photonic crystal.

### DETAILED DESCRIPTION

A. Overview

The present invention is directed toward evaluating photonic crystal (PC) microstructures on optical workpieces and other types of substrates. Many applications of the present invention are directed toward scatterometers and methods of using scatterometry to determine several parameters of periodic microstructures, pseudo-periodic structures, and other very small structures having features sizes as small as 100 nm or less. Several specific embodiments of the present invention are particularly useful in the semiconductor industry to determine the width, depth, line edge roughness, wall angle, film thickness, and many other parameters of the features formed in microprocessors, memory devices, and other semiconductor devices. The scatterometers and methods of the invention, however, are not limited to semiconductor applications and can be applied equally well in other applications.

One embodiment of the invention is directed toward a scatterometer for evaluating PC microstructures on workpieces. In this embodiment, the scatterometer comprises an irradiation source, such as a laser, a first optics assembly, and an object lens assembly. The irradiation source produces a first beam of radiation at a first wavelength. The first optics assembly is aligned with the path of the beam and configured to condition the beam (e.g., shape, randomize, select order, diffuse, converge, diverge, collimate, etc.). The object lens assembly is aligned with the path of the beam and positioned between the first optics assembly and a workpiece site. The object lens assembly is configured to focus the conditioned beam to a spot at an object focal plane. The lens assembly or other optics of the scatterometer is also configured to receive scattered radiation reflecting from a workpiece at a workpiece processing site and to present an intensity distribution of the scattered radiation in a second focal plane. The scatterometer of this embodiment can further include a detector, a navigation system, and an auto-focus system. The detector is positioned to receive at least a portion of the scattered radiation distribution and configured to produce a representation of the scattered radiation distribution. The navigation system is operatively coupled to the lens assembly or a support structure holding the workpiece, and it is configured to identify and locate the desired PC microstructure on the workpiece. The auto-focus system is operatively coupled to one of the lens assembly or the workpiece site, and it is configured to position the microstructure at the object focal plane.

Another embodiment of a scatterometer in accordance with the invention comprises a laser configured to produce a beam of radiation having a first wavelength, an optical system having a first optics assembly configured to condition the beam of radiation, and a lens assembly. The lens assembly is configured to focus the beam at an area of an object focal plane having a small spot size such that the beam has angles of incidence through a range of altitude angles of at least approximately 0°-45° and azimuth angles of at least approximately 0° to 90°. The altitude angle (Θ) is the angle between a vector normal to the object focal plane, and the azimuth angle (Ψ) is the angle normal to the reference vector in a plane parallel to the object focal plane. The beam more preferably has angles of incidence through altitude angles of 0° to greater than 70° through azimuth angles of 0°-360°. The scatterometer is further configured to collect and present the scattered radiation reflected from the microstructure in a second focal plane. In one embodiment, the lens assembly itself presents the scattered light in the second focal plane, but in other embodiments the optical system has another optic member that presents the scattered radiation distribution in the second focal plane. The scatterometer of this invention further includes a detector positioned to receive the scattered radiation distribution of the scattered radiation and configured to produce a representation of the scattered radiation distribution. The scatterometer also includes a computer operatively coupled to the detector to receive the representation of the scattered radiation distribution. The computer includes a database and a computer-operable medium. The database has a plurality of simulated scattered radiation distributions corresponding to different sets of parameters of the microstructure. The computer-operable medium contains instructions that cause the computer to identify a simulated scattered radiation distribution that adequately fits the representation of the measured scattered radiation distribution.

Another embodiment of the invention is a scatterometer for evaluating a PC microstructure on a workpiece comprising an irradiation system, an optical system, and a detector. The irradiation system includes a laser and or lamp, and the irradiation system is configured to produce a first beam of radiation having a first wavelength and a second beam of radiation having a second wavelength. The optical system has a first unit configured to condition the first and second beams. The optical system further includes a second unit configured to (a) focus the first and second beams at an area of an object focal plane having an appropriate spot size, and (b) present a distribution of scattered radiation returning from a PC microstructure in a second focal plane. The detector is positioned to receive the distribution of the scattered radiation, and the detector is configured to produce a representation of the scattered radiation distribution.

Another embodiment of a scatterometer in accordance with the invention comprises a laser configured to produce a beam of radiation having a first wavelength, an optical system, a detector, a calibration unit, and a computer. The optical system has a first optics assembly configured to condition the beam of radiation such that the beam is a diffuse and randomized beam. The optical system also includes an object lens assembly configured to (a) focus the beam at an area of an object focal plane and (b) present a distribution of scattered radiation reflected or otherwise returning from a PC microstructure in a second focal plane. The detector is positioned to receive the distribution of the scattered radiation and configured to produce a representation of the scattered radiation distribution. The calibration unit of one embodiment includes a first calibration member having a first reflectivity of the first wavelength and a second calibration member having a second reflectivity different than the first reflectivity. The first and second calibration members are located to be irradiated by the beam during a setup procedure to determine a reference reflectance. The computer is operatively coupled to the detector and includes a computer-operable medium that determines the reference reflectance using a first reflectance from the first calibration member and a second reflectance from the second calibration member.

Since PC and other optical element microstructures scatter in all directions, in yet another embodiment, the illumination optical system and detection optics are positioned on different sides of the sample piece being measured. This arrangement allows for a transmissive, as opposed to reflective, scattering measurement. For this type of transmissive scattering measurement, transmissive calibration samples having known transmissivities are used instead of reflective samples.

The present invention is also directed toward several methods for evaluating a PC microstructure on a workpiece. One embodiment of such a method comprises generating a laser beam or a beam from a lamp having a first wavelength or range of wavelengths and irradiating a microstructure on a workpiece by passing the beam through a lens assembly that focuses the beam to a focus area in an object focal plane. The focus area should have a dimension not greater than the array of scattering structures such that the incident illumination does not overall the scattering array, and the beam has a range of incidence angles having altitude angles of 0° to at least 45° and azimuth angles of 0° to greater than 90°. The method further includes detecting an actual distribution of scattered radiation returning from the microstructure.

In another embodiment of a method in accordance with the invention the procedure of irradiating a microstructure comprises irradiating the focus area with a laser beam having a first wavelength and irradiating the focus area with a laser beam having a second wavelength different than the first wavelength. For example, the first wavelength can be approximately 244 nm and the second wavelength can be approximately 457 nm. The workpieces are irradiated with one or more beams having one or more wavelengths less than 500 nm in several specific embodiments, but longer wavelengths like 532 nm or 633 nm, or infrared wavelengths, may be used in other embodiments. Another aspect in accordance with another embodiment of the invention includes calibrating the detector by providing a first calibration member having a first reflectivity and a second calibration member having a second reflectivity. The system can be calibrated by determining a reference reflectance using a first reflectance from the first calibration member and a second reflectance from the second calibration member. Other embodiments can use only a single calibration member.

The invention resides in the systems and methods described, as well as in sub-systems and sub-combinations of their elements and steps. The elements or steps of one embodiment may be equivalently used as well in other embodiments.

B. Embodiments of Scatterometers and Methods for Evaluating Microstructures on Workpieces

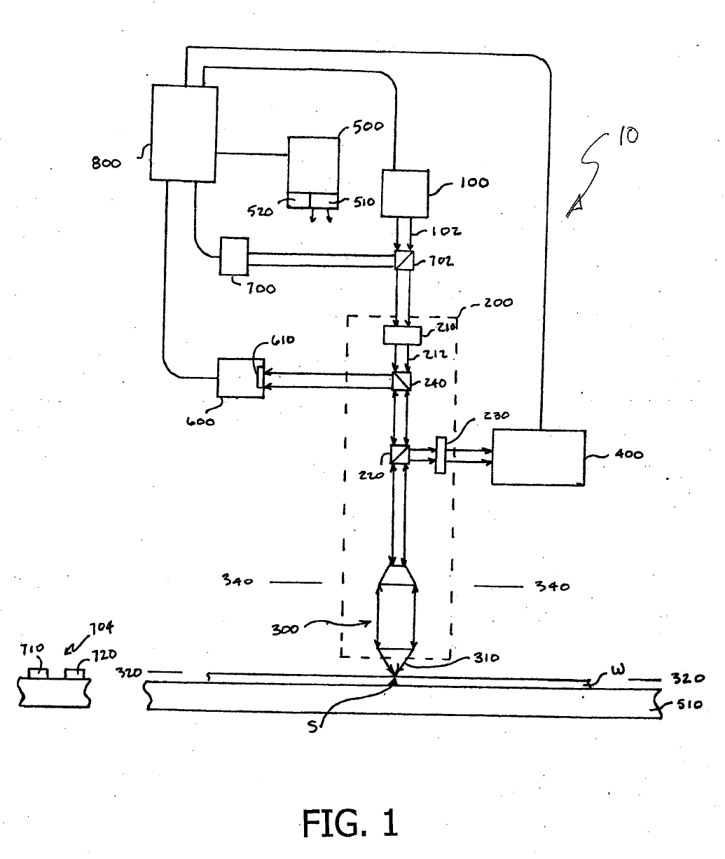

FIG. 1 is a schematic illustration of a scatterometer 10 in accordance with an embodiment of the invention. In this embodiment, the scatterometer 10 includes an irradiation source 100 that generates a beam 102 at a desired wavelength. The irradiation source 100 can be a monochromatic light source, such as a laser system and/or lamp capable of producing (a) a beam 102 at a single wavelength, (b) a plurality of beams at different wavelengths, or (c) any other output having a single wavelength or a plurality of wavelengths. In many applications directed toward assessing microstructures on semiconductor workpieces, the irradiation source 100 is a laser that produces a beam having a wavelength less than 500 nm, and more preferably in the range of approximately 150 nm-500 nm. In a different embodiment, the irradiation source 100 can include a plurality of different lasers and/or filters to produce a first beam having a first wavelength of approximately 244 nm and a second beam having a second wavelength of approximately 457 nm. For applications directed towards PC structures, the desired wavelength will typically be larger, preferably in the range of 400-800 nm. It will be appreciated that the irradiation source 100 can produce additional wavelengths having shorter or longer wavelengths in the UV spectrum, visible spectrum, and/or other suitable spectrum. The irradiation source 100 can further include a fiber optic cable to transmit the beam 102 through a portion of the apparatus.

The scatterometer 10 further includes an optical system 200 between the irradiation source 100 and a workpiece W. In one embodiment, the optical system 200 includes a first optics assembly 210 that conditions the beam 102 to form a conditioned beam 212. The first optics assembly 210, for example, can include a beam diffuser/randomizer that diffuses and randomizes the radiation to reduce or eliminate the coherence of the beam 102. The first optics assembly 210 can also include a beam element that shapes the beam to have a desired cross-sectional dimension, shape, and/or convergence-divergence. The beam element, for example, can shape the beam 212 to have a circular, rectilinear, or other suitable cross-sectional shape for presentation to additional optic elements downstream from the first optics assembly 210. The first optics assembly may also include optical components whose positions may be varied to produce different beam conditions, such as a spot size or shape which may be optimized for the one particular photonic crystal measurement.

The optical system 200 can further include an object lens assembly 300 that focuses the conditioned beam 212 for presentation to the workpiece W and receives radiation reflected from the workpiece W. The object lens assembly 300 is configured to receive the conditioned beam 212 and form a convergent beam 310 focused at a discrete focus area S on an object focal plane 320. The convergent beam 310 can have a conical shape when the conditioned beam 212 has a circular cross-section, but in other embodiments the convergent beam 310 can have other shapes. For example, when the conditioned beam 212 has a rectilinear cross-section, the convergent beam 310 has a pyramidal shape. As explained in more detail below with reference to Section C, the convergent beam 310 can have a range of incidence angles having altitude angles of 0° to greater than approximately 70° and having azimuth angles of 0° to greater than 90° and more preferably 0-360°. The altitude angle is the angle from a reference vector normal to the object focal plane 320, and the azimuth angle is the angle in a plane parallel to the object focal plane 320 and normal to the reference vector. The large range of incidence angles generates a large number of scattered angles and hence unique data points that enable accurate evaluations of several parameters of the photonic crystal microstructure.

The focus area at the object focal plane 320 preferably has a size and shape suitable for evaluating the particular photonic crystal microstructure, and as has been previously discussed, should fill a large region of the photonic crystal array but not exceed it. For example, when the photonic crystal on the workpiece has a maximum dimension of approximately 100-200 μm, then the focus area is also approximately 100-200 μm. The size of the focal area is preferably not greater than the size of the photonic crystal array so that the radiation does not scatter from features outside of the PC. In many applications, therefore, the object lens assembly 300 is configured to produce a spot size generally less than 200 μm, and more preferably less than 100 μm. The scatterometer 10 can have larger focus areas in other embodiments, such as when the LED emission area is large

The object lens assembly 300 is further configured to collect the scattered radiation reflecting from the workpiece W and present the scattered radiation on a second focal plane 340. The object lens assembly 300, more particularly, presents the scattered radiation in a manner that provides a distribution of the scattered radiation at the second focal plane 340. In one embodiment, the object lens assembly 300 directs the scattered radiation coming at particular angles from the object focal plane 320 to corresponding points on the second focal plane 340. Additional aspects of specific embodiments of the object lens assembly 300 are described below with reference to Section C.

The optical system 200 can further include a beam splitter 220 through which the conditioned beam 212 can pass to the object lens assembly 300 and from which a portion of the return beam propagating away from the second focal plane 340 is split and redirected. The optical system 200 can optionally include a second optics assembly 230 that receives the split portion of the return beam from the beam splitter 220. The second optics assembly is configured to prepare the return beam for imaging by an imaging device. Additional aspects of specific embodiments of the second optics assembly 230 are described below with reference to Section C.

The scatterometer 10 further includes a detector 400 positioned to receive the intensity distribution propagating back from the second focal plane 340. The detector 400 can be a CCD array, CMOS imager, other suitable cameras, or other suitable energy sensors for accurately measuring the scattered radiation distribution. The detector 400 is further configured to provide or otherwise generate a representation of the scattered radiation distribution. For example, the representation of the distribution can be data stored in a database, an image suitable for representation on a display, or other suitable characterizations of the scattered radiation distribution. Several embodiments of the detector 400 are described below in greater detail with reference to Section D.

The scatterometer 10 can further include a navigation system 500 and an auto-focus system 600. The navigation system 500 can include a light source 510 that illuminates a portion of the workpiece W and optics 520 that view the workpiece W. As explained in more detail below, the navigation system 500 can have a low magnification capability for locating the general region of the PC structure on the workpiece (e.g., global alignment), and a high magnification capability for precisely identifying the location of the PC structure to be measured. Several embodiments of the navigation system can use the irradiation source 100 and components of the optical system 200. The navigation system 500 provides information to move the object lens assembly 300 and/or a workpiece site 510 to accurately position the focus area of the object lens assembly 300 at the desired PC structure on the workpiece W.

The auto-focus system 600 can include a focus array 610, and the optical system 200 can include an optional beam splitter 240 that directs radiation returning from the workpiece W to the focus array 610. The auto-focus system 600 is operatively coupled to the object lens assembly 300 and/or the workpiece site 510 to accurately position the PC structure on the workpiece W at the object focal plane 320 of the object lens assembly 300. As explained in more detail below with reference to Section E, the navigation system 500 and the auto-focus system 600 enable the scatterometer 10 to evaluate the highly variable size and positions of photonic crystal arrays on a workpiece.

The scatterometer 10 further includes a calibration system for monitoring the properties of the input beam 102 and maintaining the accuracy of the other components. The calibration system (a) monitors the intensity, phase, polarization, wavelength or other beam property of the beam 102 in real time, (b) provides an accurate reference reflectance for the detector 400 to ensure the accuracy of the scatterometer, and/or (c) provides angular calibration of the system. In one embodiment, the calibration system includes a detector 700 and a beam splitter 702 that directs a portion of the initial beam 102 to the detector 700. The detector 700 monitors changes in the intensity of the beam 102 in real-time to continuously maintain the accuracy of the measured intensity distribution of the radiation from the workpiece W. The detector 700 can also or alternatively detect phase changes, polarization, beam shape and directionality, or a differential intensity.

The calibration system can further include a calibration unit 704 having one or more calibration members for calibrating the detector 400. In one embodiment, the calibration unit 704 includes a first calibration member 710 having a first reflectance of the wavelength of the beam and a second calibration member 720 having a second reflectance of the wavelength of the beam. The first calibration member 710 can have a very high reflectance, and the second calibration member 720 can have a very low reflectance to provide two data points for calibrating the detector 400.

The scatterometer 10 further includes a computer 800 operatively coupled to several of the components. In one embodiment, the computer 800 is coupled to the irradiation source 100, the detector 400, the navigation system 500, the auto-focus system 600, and the reference detector 700. The computer 800 is programmed to operate the irradiation source 100 to produce at least a first beam having a first wavelength and preferably to also produce a second beam having a second wavelength, as described above. The computer 800 can also control the source 100 to control the output intensity of the beam. The computer 800 further includes modules to operate the navigation system 500 and auto-focus system 600 to accurately position the focus area of the convergent beam 310 at a desired location on the wafer W and in precise focus.

In several embodiments, the computer 800 further includes a computer-operable medium for processing the measured scattered radiation distribution to provide an evaluation of the PC structure on the workpiece W. For example, the computer 800 can include a database having a plurality of simulated intensity distributions corresponding to known parameters of the photonic crystal structure. The computer 800 can include computer-operable media to process the measured intensity distribution in conjunction with the database of simulated intensity distributions in a manner that selects the simulated intensity distribution that best fits the measured intensity distribution. Based upon the selected simulated intensity distribution, the computer stores and/or presents the parameters of the microstructure corresponding to those of the simulated intensity distribution, or an extrapolation or interpolation of such parameters. Several aspects of the computer 800 and methods for processing the measured intensity distribution are set forth below in greater detail with reference to Section G.

C. Embodiments of Optics and Lens Assemblies

The scatterometer 10 can have several different embodiments of optics assemblies and lens assemblies for optimizing the scatterometer for use with specific types of photonic crystal structures. The object lens assembly 300, for example, can be achromatic to accommodate a plurality of beams at different wavelengths, or it can have a plurality of individual assemblies of lenses that are each optimized for a specific wavelength. Such individual lens assemblies can be mounted on a turret that rotates each lens assembly in the path of the beam according to the wavelength of the particular beam. In either case, the object lens assembly 300 is useful for applications that use different wavelengths of radiation to obtain information regarding the radiation returning from the workpiece.

The object lens assembly 300 can also include reflective lenses that are useful for laser beams or lamp illumination in the UV spectrum. Certain types of glass may filter or attenuate UV radiation. As such, when the beam has a short wavelength in the UV spectrum, the object lens assembly 300 and other optic members can be formed from reflective materials that transmit the UV radiation. In another embodiment, the first optics assembly 210 or the object lens assembly 300 may have a polarizing lens that polarizes the radiation for the convergent beam 310 (FIG. 1).

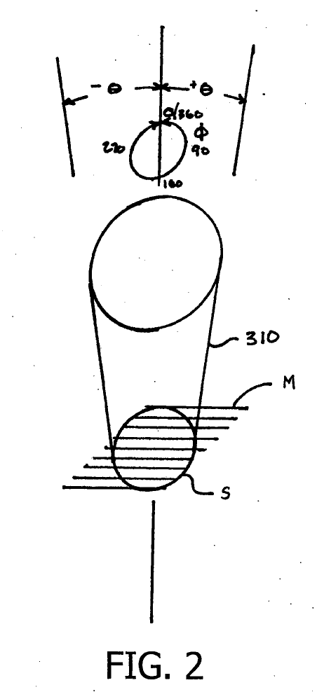

FIG. 2 illustrates one embodiment of the convergent beam 310 explained above with reference to FIG. 1 formed by an embodiment of the object lens assembly 300. The convergent beam 310 illustrated in FIG. 2 has a frusto-conical configuration that results in a focus area S. The focus area S is smaller than the area of the microstructure under evaluation. In several particular applications for the LED industry, the focus area S is approximately 10-200 μm in diameter, and more preferably approximately 20-30 μm in diameter. The focus area S, however, is not limited to these ranges in other embodiments. The focus area S may not necessarily be circular, and thus the convergent beam 310 is typically configured such that the focus area S has a maximum dimension less than 30 μm (e.g., approximately 50 nm to approximately 30 μm).

The convergent beam 310 simultaneously illuminates a microfeature M through a wide range of incidence angles having large ranges of altitude angles Θ and azimuth angles Φ. Each incidence angle has an altitude angle Θ and an azimuth angle Φ. In general, the incidence angles have altitude angles Θ of 0° to at least 45°, and more preferably from 0° to greater than 70°. The range of azimuth angles Φ can be 0° to greater than approximately 90°, and more preferably throughout the entire range of 0° to 360°. As a result, the object lens assembly 300 can form a conical beam having a large range of incidence angles (Θ, Φ) to capture a significant amount of data in a single measurement of the workpiece W. This is expected to enhance the utility and throughput of scatterometry for measuring photonic crystal structures, which due to their complexity will produce a complicated scattering pattern.

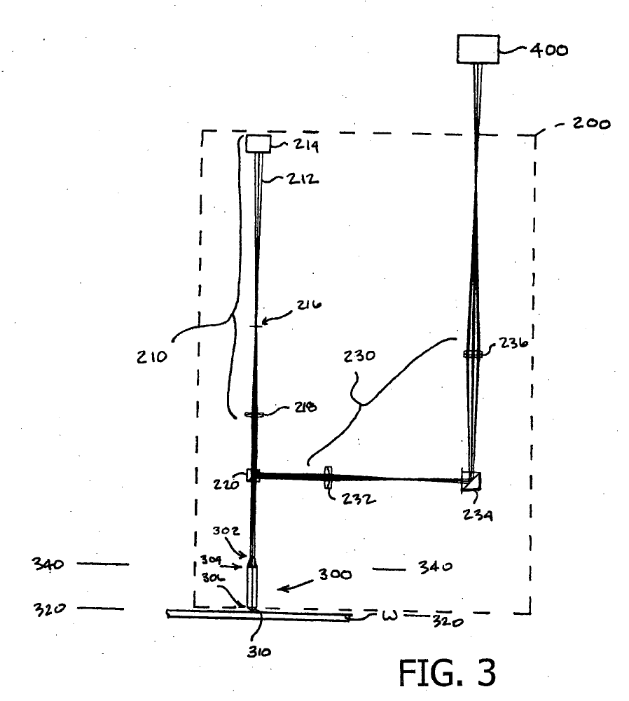

FIG. 3 is a schematic diagram illustrating a specific embodiment of the optical system 200 in accordance with the invention. In this embodiment, the first optics assembly 210 includes a beam conditioner 214 that produces a conditioned beam 212 including diffused and randomized radiation. The beam conditioner 214 can be a fiber optic line that transmits the beam from the irradiation source (not shown in FIG. 3) and an actuator that moves the fiber optic line to randomize the laser beam. The actuator can move the beam conditioner 214 in such a way that it does not repeat its movement over successive iterations to effectively randomize the radiation.

The beam conditioner 214 can further include or alternatively be an order sorter for removing undesired diffraction orders from the output. For example, the beam conditioner 214 may form a conditioned beam that provides a limited input to the object lens assembly 300 so that only a single, specific diffraction illuminates pre-selected parts of the detector. The beam conditioner 214 may include a carousel of apertures placed at the input of the optical system 200 so that different input apertures may be selected according to the desired diffraction order of the conditioned beam 212.

The first optics assembly 210 can further include a field stop 216 and an illumination lens 218. The field stop 216 is positioned in the first focal plane of the illumination lens 218, and the field stop 216 can have an aperture in a desired shape to influence the spot size and spot shape in conjunction with the illumination lens 218. In general, the illumination lens 218 collimates the radiation for presentation to the object lens assembly 300.

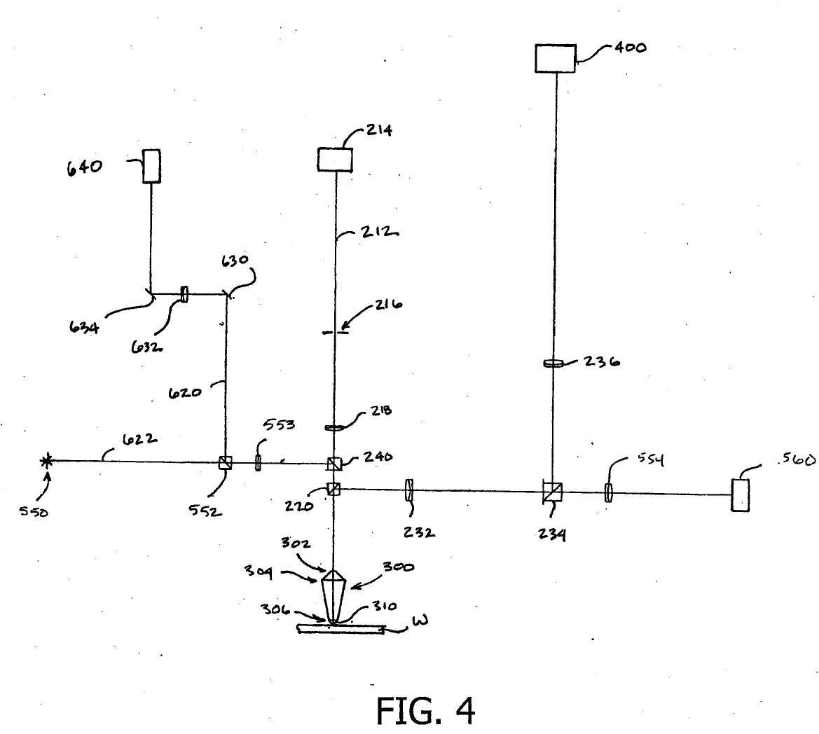

The embodiment of the object lens 300 illustrated in FIG. 3 can include a plurality of separate lenses. For example, the object lens assembly 300 can include a divergent lens 302, a first convergent lens 304, and a second convergent lens 306. The first convergent lens 304 can have a first maximum convergence angle, and the second convergent lens 306 can have a second maximum convergence angle (see FIG. 4). In operation, the object lens assembly 300 (a) focuses the conditioned beam 212 to form the convergent beam 310 and (b) presents the return radiation from the workpiece W on the second focal plane 340. The location of the second focal plane 340 depends upon the particular configurations of the lenses 302, 304 and 306. For purposes of illustration, the second focal plane 340 is shown as coinciding with the location of the first convergent lens 304.

The embodiments of the first optics assembly 210 or object lens 300 may include elements whose position may be varied or altered so as to produce different input beam conditions, such as a variable spot size or shape. This particular embodiment is expected to have great utility to photonic crystal measurements, where the overall array size of the PC structure may vary from one device to another.

The embodiments of the first optics assembly 210 or object lens 300 may include elements whose position may be varied or altered so as to project a near field or far field scattered radiation distribution at the detector 400.

The object lens assembly 300 is configured such that the angle (Θₓ, Φ_{y}) of rays within the convergent beam 310 will pass through corresponding points (x, y) in the second focal plane 340. As a result, radiation passing through any given point (x, y) in the second focal plane 340 toward the workpiece W will pass through the object focal plane 320 at a particular corresponding angle (Θₓ, Φ_{y}), and similarly radiation reflecting from the object focal plane 320 at a particular angle (Θₓ, Φ_{y}) will pass through a unique point (x, y) on the second focal plane 340. The reflected radiation passing through the second focal plane 340 propagates to the beam splitter 220 where it is directed toward the second optics assembly 230.

The second optics assembly 230 includes a relay lens 232, an output beam splitter 234, and an image-forming lens 236. The relay lens 232 and output beam splitter 234 present the reflected and/or diffracted radiation (i.e., return radiation) from the beam splitter 220 to the image-forming lens 236, and the image-forming lens 236 “maps” the angular distribution of reflectance and/or diffraction (i.e., the scattered radiation distribution) from the second focal plane 340 to the imaging array of the detector 400. In a particular embodiment, the image-forming lens 236 preferably presents the image to the detector 400 such that the pixels of the imager in the detector 400 can be mapped to corresponding areas in the second focal plane 340.

D. Embodiments of Detectors

The detector 400 can have several different embodiments depending upon the particular application. In general, the detector is a two-dimensional array of sensors, such as a CCD array, a CMOS imager array, or another suitable type of “camera” or energy sensor that can measure the scattered radiation from the workpiece W corresponding to the distribution at the second focal plane 340. The detector 400 may be configured to measure intensity, phase, polarization or cross-polarization, or wavelength of the scattered radiation. The detector may be a reflectometer, polarimeter or ellipsometer. In one embodiment, the detector 400 further includes a polarizer such as a rotating polarizer or a sheet polarizer to change the polarization of the light. The orthogonally polarized radiation can be used together or separately to measure certain characteristics that are otherwise undetectable from non-polarized light. As such, polarizing the reflected radiation can optimize the response to increase the resolution and accuracy of the scatterometer 10.

E. Navigation and Auto-Focus Systems

The navigation system 500 accurately aligns the beam 310 with a desired area on the workpiece W, and the auto-focus system 600 adjusts the object lens assembly 300 or workpiece site 510 so that the object focal plane 320 is at the microstructure. In one embodiment, the navigation system 500 has a separate illumination source, lens and measurement optics for determining the precise location of the microstructure on the workpiece W. The light source of the navigation system 500 can be a LED, and the lens and optics can be a two-stage system having low and high magnifications. The low magnification stage identifies the general area on the wafer where the microstructure is located, and the high magnification stage refines the location. In other embodiments, the navigation system 500 can include additional relay optics introduced to image the surface directly through the object lens assembly 300.

The auto-focus system 600 can be a camera correlation focus system having a dihedral mirror that simultaneously splits the illumination pupil in two and redirects the light from the two halves of the dihedral mirror to different sections of a CCD array. The displacement between the two images is used to automatically determine the focus. A field stop can be incorporated to prevent overlap of the two images on the focus camera. The field stop is included in the illumination beam of the microscope of the auto-focus system.

FIG. 4 is a schematic illustration of an embodiment of the navigation system 500 and auto-focus system 600 for use in the scatterometer. Several aspects of FIG. 4 are similar to those explained above with reference to FIGS. 1 and 3, and thus like reference numbers refer to like components in these figures. The navigation system 500 can have a high magnification system associated with the metrology system. For example, the high magnification system includes a light source 550, such as an LED, that injects light via a beam splitter 552 and is focused on the second focal plane by a relay lens 553 via beam splitter 240. This light illuminates the workpiece and is reflected back through the object lens assembly 300. The reflected light is directed by beam splitter 220 and through lenses 232 and 554 to camera 560. The lenses 232 and 554 form an image of the PC structure on the camera 560.

The auto-focus system 600 in this embodiment shares the relay lens 553 and the beam splitter 552 with the navigation system. The beam splitter 552 directs a beam 620 to a dihedral mirror 630, an image lens 632, and a steering mirror 634. The first beam 620 is then received by an auto-focus detector 640, such as a CCD array or other type of camera.

F. Calibration

The calibration system is used to monitor the properties of the initial beam 102 (FIG. 1) and calibrate the system efficiency for accurately detecting the scattered radiation distribution. The beam properties are monitored by a reference detector 700 that receives a portion of the beam 102 in real time. As the beam fluctuates, the reference detector 700 detects the changes in the beam 102 and sends a signal to the computer 800. The computer 800 accordingly adjusts the measured intensity distribution by the variances in the intensity of the initial beam 102 to eliminate errors caused by small changes in the beam 102. Unlike some systems that do this periodically, the computer 800 continuously receives signals from the reference detector 700 to maintain the accuracy of the system in real time. This is expected to significantly enhance the accuracy and precision with which the scatterometer 10 can evaluate extremely complex features in PC structures.

The calibration system can also include a calibration unit, such as the calibration unit 704 (FIG. 1) with one or more calibration members, for providing photometric calibration of the system. In one embodiment, the first calibration member 710 can be a highly reflective mirror having a reflectance greater than 95%, and more preferably a reflectance of approximately 99.99%. The first calibration member 710 can be configured to have a consistent reflectance through a wide range of altitude angles. The second calibration member 720 is preferably a black glass having a low reflectance (e.g., 0% to 10%). In operation, the detector 400 is calibrated by measuring the reflectance of the beam from the first calibration member 710 and from the second calibration member 720 to provide two data points corresponding to the known 99.99% reflectance of the first calibration member 710 and the known 0% reflectance of the second calibration member 720. Using these two data points, a straight line can be obtained to provide a reference reflectance of the detector 400.

The scatterometer can be calibrated further using several different methods. For example, a known grating with a known intensity distribution can be measured using the scatterometer 10 to determine whether the detector 400 accurately produces a representation of the intensity distribution. In another embodiment, a thin film having a known thickness can be irradiated to determine whether the detector 400 provides an accurate representation of the intensity distribution from such a thin film. Both of these techniques can also be combined for yet another calibration method.

G. Computational Analyses

The computer 800 can use several different processes for determining one or more parameters of the microstructure based on the measured intensity distribution from the detector 400. In general, the computer 800 compares the measured intensity distribution with one or more simulated intensity distributions corresponding to selected parameters of the features and materials of the microstructure (e.g., height, width, line edge roughness, roundness of edge corners, spacing, film thickness, refraction index, reflection index, and/or other physical properties). Based on the comparison, the computer 800 then stores and/or provides an output of one or more parameters of the microstructure.

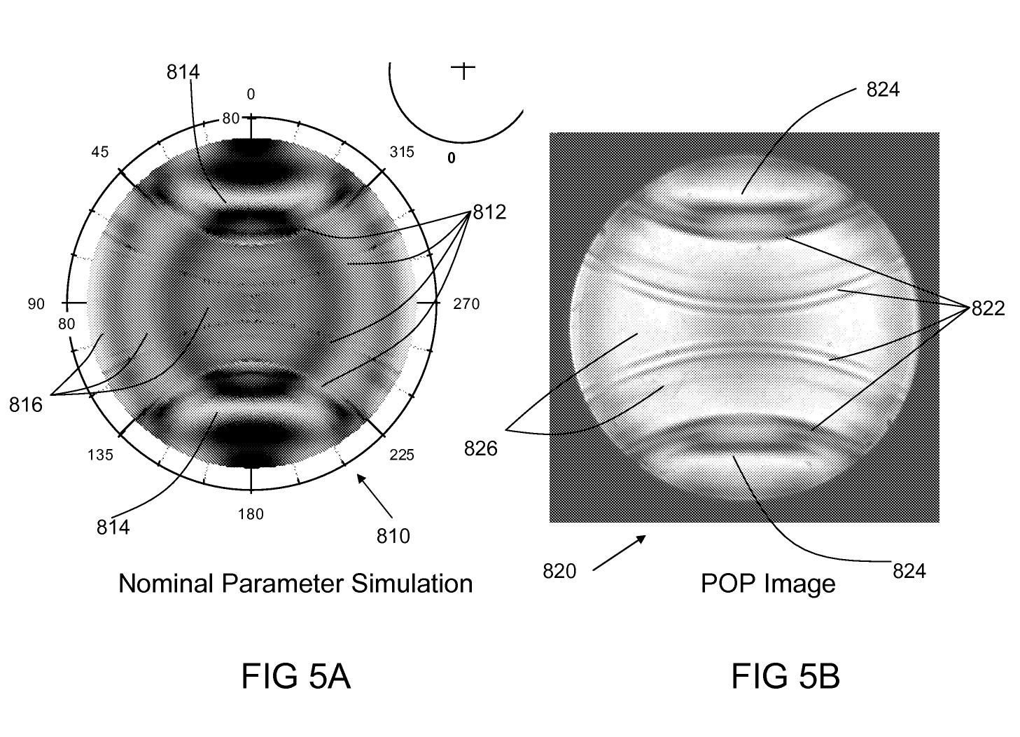

FIG. 5A is an image illustrating a simulated scattered radiation intensity distribution 810 having a first interference pattern 812 including a plurality of thin arcs, a second interference pattern 814 including a plurality of different arcs, and a third interference pattern 816 in a configuration of a “bulls-eye.” The first interference pattern 812 can correspond to the specular reflections, the second interference pattern 814 can correspond to higher order diffractions, and the interference pattern 816 can correspond to the film thickness. The interference patterns of the simulated intensity distribution 810 are unique to each set of feature parameters, and thus changing one or more of the feature parameters will produce a different simulated intensity distribution.

FIG. 5B is an image of a measured intensity distribution 820 of an actual microstructure on a workpiece. The measured intensity distribution 820 includes a corresponding first interference pattern 822, a second interference pattern 824, and a third interference pattern 826. In operation, the computer 800 ascertains the parameters of the microstructure by selecting and/or determining a simulated intensity distribution 810 that best fits the measured intensity distribution 820.

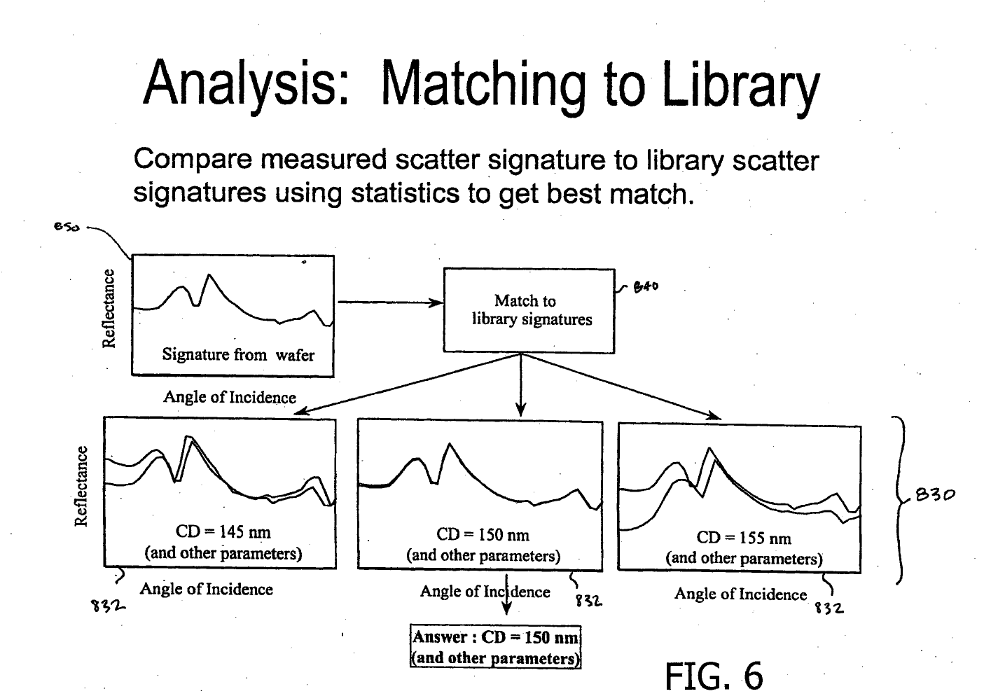

FIG. 6 illustrates one embodiment for ascertaining the feature parameters of the microstructure. In this embodiment, the computer 800 includes a database 830 including a large number of predetermined simulated reference intensity distributions 832 corresponding to different sets of feature parameters. The computer 800 further includes a computer-operable medium 840 that contains instructions that cause the computer 800 to select a simulated intensity distribution 832 from the database 830 that adequately fits a measured intensity distribution 850 within a desired tolerance. The computer-operable medium 840 can be software and/or hardware that evaluates the fit between the stored simulated intensity distributions 832 and the measured intensity distribution 850 in a manner that quickly selects the simulated intensity distribution 832 having the best fit with the measured intensity distribution 850 or at least having an adequate fit within a predetermined tolerance. In the case where a plurality of the simulated intensity distributions 832 have an adequate fit with the measured intensity distribution 850, the computer 800 can extrapolate or interpolate between the simulated distributions. Once the computer has selected a simulated intensity distribution with an adequate fit or the best fit, the computer selects the feature parameters associated with the selected simulated distribution.

In an alternative embodiment, the computer calculates a simulated intensity distribution and performs a regression optimization to best fit the measured intensity distribution with the simulated intensity distribution in real time. Although such regressions are widely used, they are time consuming and they may not reach a desired result because the regression may not converge to within a desired tolerance.

In still other embodiments, the computer 800 may perform further processing or different processing such as finite element models for evaluating non-periodic or pseudo-periodic structures. The computer 800 may also be able to solve for the refraction index and reflectivity index of the particular materials by determining the film thickness. Therefore, the enhanced data in the measured intensity distribution enables the computer 800 to more accurately determine the feature parameters of the microstructure and may enable more feature structures to be monitored (e.g., line edge roughness, refraction index, reflectivity index, etc.).

In a surprising discovery, it has been found that scatterometry is also useful for measuring dimensions or angles of optical devices, and lighting devices, such as light emitting diodes (LEDs), lasers and optical waveguides having periodic or patterned features like photonic crystal structures.

Relative to optical devices, it is significant that scatterometry is an optical metrology or measuring technique based on the analysis of light scattered from an array of features. When an array of features is illuminated with a light source, the reflectance properties of the scattered and/or diffracted light varies with the structure and composition of the scattering features themselves. Consequently, by analyzing the light scattered from the features, various precise non-destructive and rapid measurements of the features can be obtained. Although commonly referred to as scatterometry, the so-called scatter of the light generally results from diffraction, in contrast to random scattering.

The present systems and methods can also be used not only for measuring, but also for designing more optimized optical or lighting devices, such as LEDs. By essentially reversing the light measurement and analysis process through simulations, the light output characteristics of devices such as PC-LEDs may be analytically predicted. The use of specific beam profile models may be integrated with the scattering simulations to simulate highly specific device conditions. Consequently, the geometry and/or dimensions of highly efficient light emitting devices can be calculated. This helps to reduce or avoid the slow, time consuming and costly trial and error development steps of device manufacturing.

While LED's now in use are low power devices (about 5 watts maximum) and are costly in comparison to conventional lighting sources, they have several important advantages. LEDs consume far less power than equivalent lighting sources, such as incandescent, or even fluorescent bulbs. They also last far longer, and are much more durable, than virtually any conventional bulbs. It is generally presumed that LED's will eventually replace conventional lighting all together. This would allow for massive conservation of electricity and materials on a global scale, and a corresponding reduction in use of combustion fuels. Generation of exhaust and greenhouse gases would also be greatly reduced. So-called solid state lighting could also be created in various ways, and in various places not conceivable with conventional bulbs.

LEDs create visible light by forcing together positive and negative electric charge carriers in a region where two different types of semiconductor material meet. Voltage drives the electrons and holes to an active layer at the boundary between the n- and p-type materials. When an electron and a hole meet, they release energy in the form of a photon. A photon is the smallest particle of light.

However, not all photons escape from the LED device to provide useful visible light. Impurities and defects or dislocations in the crystal structure of the LED materials absorb photons. A large fraction, or even a majority of the light generated by an LED, is absorbed and not emitted from the LED. LEDs must be able to provide significantly more light before they can replace incandescent and fluorescent lighting.

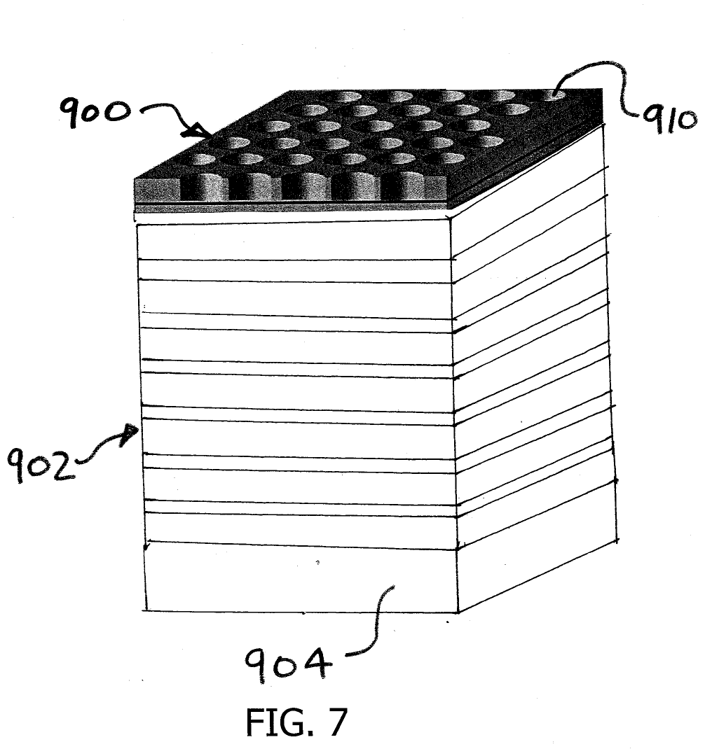

Recent research in the LED field suggests that more light can be obtained from LED's by applying patterned scattering structures above the emission region of the LED. These scattering structures are generally known as photonic crystals (PCs) but are also known as photonic band gap crystals. Although PCs may come in various forms, a typical PC, as shown in FIG. 7, has a repeating pattern of features, such as holes or openings. The holes are typically e.g., about 200 or 300-600 nm in diameter, and with a pitch or spacing generally about 1.5-2.5 times the diameter. The performance of the PC depends on accurately holding various design parameters (such as dimensions and angles) within specified tolerances. As a result, these design parameters must be measured if PCs are to be successfully and economically manufactured on a large scale.

The inventors have discovered that systems and methods described above in connection with FIGS. 1-6 may be modified and used to perform scatterometry measurements on photonic crystals. This is a surprising result for several different reasons. Initially, scatterometry has been developed and used, in the semiconductor device industry, on silicon based devices. Silicon has relatively low light transmissivity. In contrast, LEDs and PCs are made of relatively transparent optical materials, such as gallium nitride and sapphire, having much higher transmissivity. In silicon devices, the substrate is virtually opaque, so that there is little, if any, substrate optical effect. On the other hand, with optical devices such as LEDs, the substrates are much more transparent. This creates significant substrate optical effects. Similarly, in silicon, multiple buried or underlying layers, even if present, have little effect on scatterometry. As shown in FIG. 7, LEDs however typically have large numbers of internal layers. The interface between each set of layers causes refraction and internal reflections. Hence the optical characteristics are entirely different from silicon.

In addition, silicon has a cubic crystal structure, while the optical materials used in LEDs and PCs generally have hexagonal crystal structures. Silicon devices are largely made up of micro structures formed in straight lines. Optical structures typically involve curved or round structures (although some may also include straight lines or features). In silicon devices, the straight lines or features are generally used to interconnect areas or microelectronic components formed on the substrate. Optical structures tend to have periodic or repeating patterns, without extensive interconnect lines. For these reasons, use of scatterometry for measurement of PC features is more complicated.

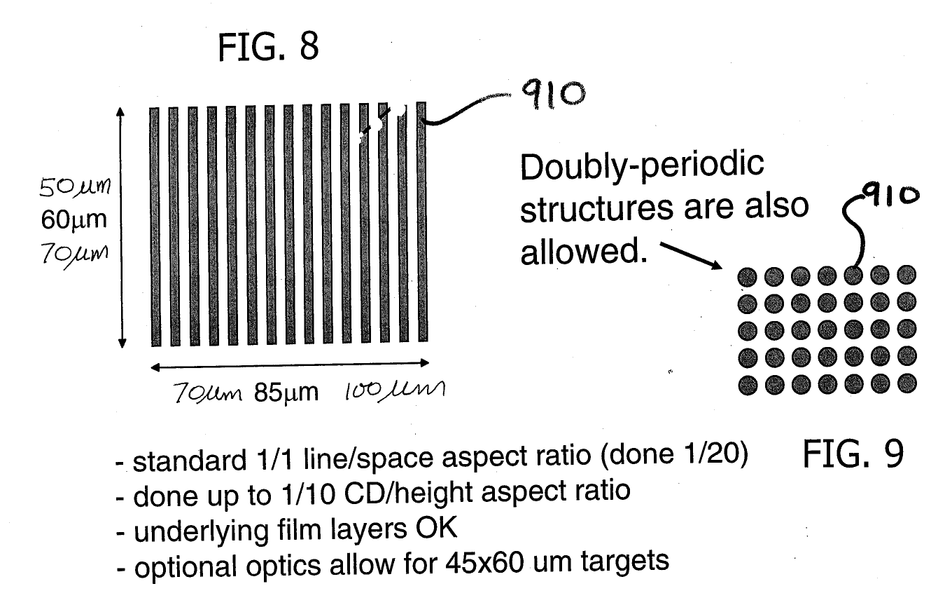

Referring to FIGS. 8 and 9, the target area having a periodic pattern is preferably about 50-70 or about 60 microns by about 70-100 or about 85 microns. With additional optics, the target area can be reduced to about 40-50 or about 45 microns by about 50-70 or about 60 microns. The periodic pattern need not fill the entire target area. Especially if the periodic pattern is surrounded by a uniform surface, the pattern itself may be much smaller that the target area. Of course, the pattern may also be larger than (or overfill) the target area as well. In general terms, 8-12 cycles of a repeating pattern are needed to obtain acceptable measurement results. However, the minimum number of cycles needed will vary based on several factors.

FIG. 9 shows a basic doubly periodic structure similar to the photonic crystal shown in FIG. 7. The holes are round, and the holes are aligned in a square pattern. With a nominal hole diameter of e.g. 500 nm, and with the holes spaced apart at e.g., 750 nm centers, the target area shown in FIG. 8 would overlay an array of holes having about 110 columns and about 80 rows. The array in FIG. 9 is not drawn to scale relative to the target area shown in FIG. 8, as FIG. 8 is described in micron units and FIG. 9 is described in nanometers. With respect to a general minimum number of cycles of a pattern, for example, 10 of the rows or columns in FIG. 9 would occupy only 7.5 microns.

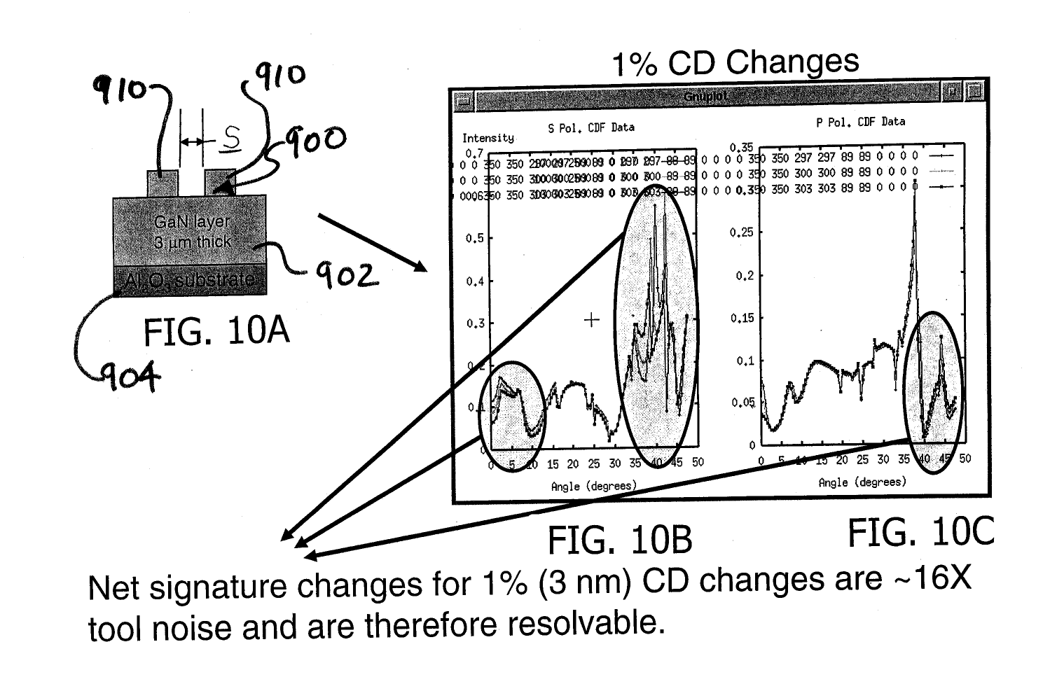

FIG. 10A is a section view of a gallium nitride (GaN) LED with a photonic crystal. The photonic crystal 900 is formed as a layer on the LED 902. The LED itself is based on a substrate 904. Various known materials and techniques may be used to the form the PC 900 and the LED 902. FIG. 10B shows actual simulated data from an intensity distribution of the structure shown in FIG. 10A. FIG. 10C shows the same data when the critical dimension (i.e., the dimension of interest here, which is the spacing S between adjacent scattering features 910) is changed by 1% or 3 nm. Comparison of FIGS. 10B and 10C shows that measurement sensitivity for scatterometry on the PC/LED structure is resolvable.

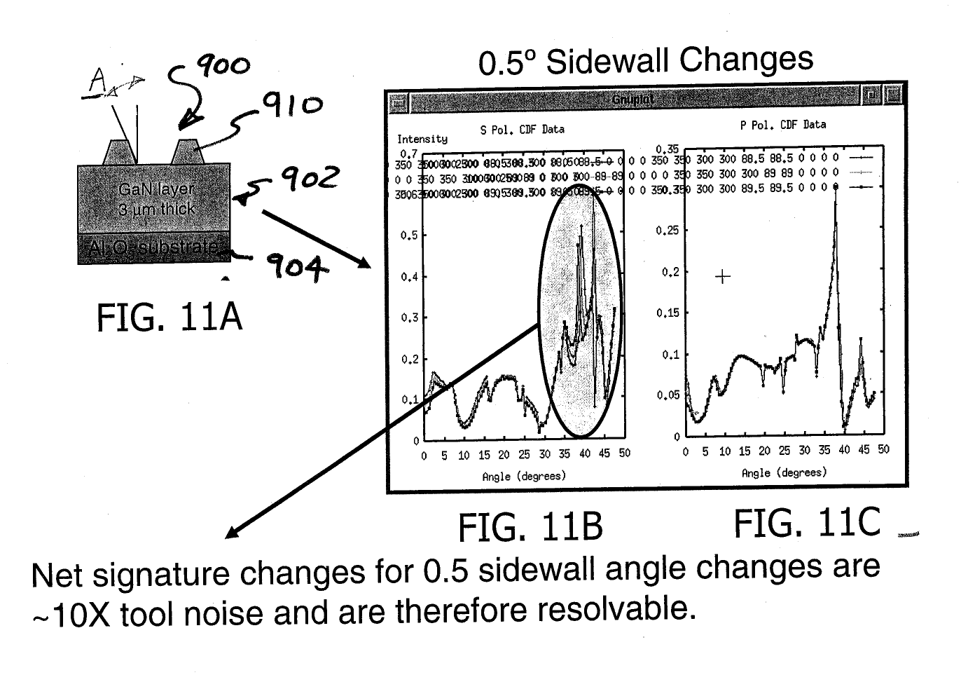

FIGS. 11A, B, and C are similar to FIGS. 10 A, B and C, except that the dimension of interest is the sidewall angle A. The angle A is greatly exaggerated for purpose of illustration. A 0.5 degree change in the sidewall angle is resolvable.

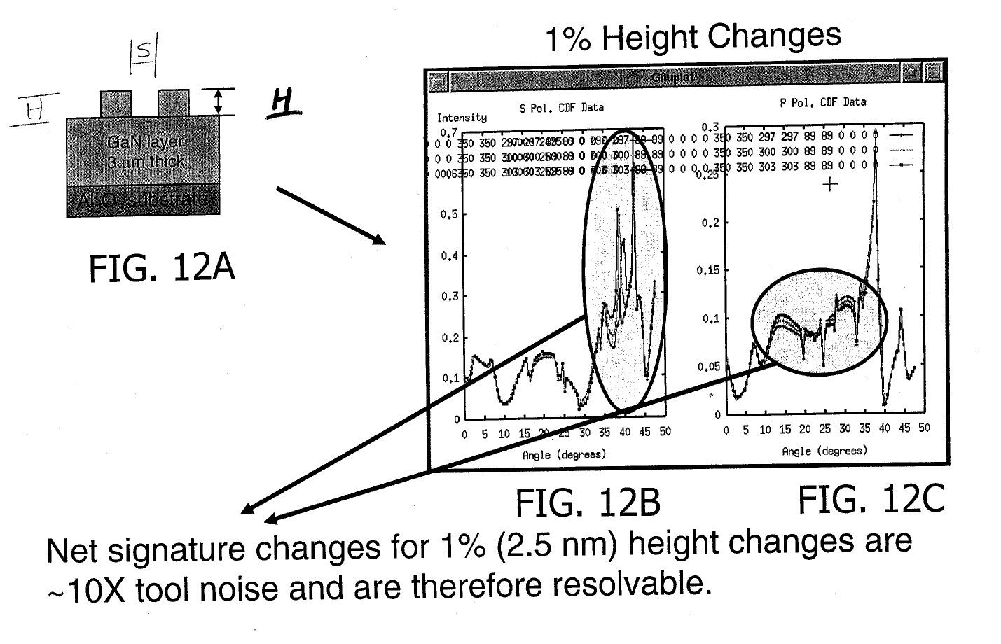

FIGS. 12 A, B, and C are similar to FIGS. 10A, B and C, except that the dimension of interest is the height of the feature 910. The plotted data shows that a 1% change (2.5 nm) in the height of the feature 910 is resolvable. FIGS. 10A, B, and C, FIGS. 11A, B and C, and FIGS. 12A, B and C show that scatterometry systems and methods can be used to measure PC structures, notwithstanding the complexities of multiple layers and transmissive materials.

In these Figures, the data shows extreme spikes at certain angles of incidence, which is unknown in silicon scatterometry. These spikes have been found to be characteristic of scatterometry of optical materials, such as the PC/LED combination shown in FIG. 10A. As a result, smaller increments in change of incident angle are used to avoid loss of detail. For example, rather than using 1 or 2 degree increments (as is typical for silicon), the increment is reduced to 0.5, 0.4, 0.3, 0.2 or 0.1 degree, in regions having spikes. These regions can be determined from the database of simulated intensity distributions. To avoid slowing excessively slowing down the measuring process, larger 1 or 2 degree increments may be used at flatter areas of the intensity plots, and much finer increments may be used at the spiked regions.

While the results from FIGS. 10-12 were obtained using a database of intensity distributions, the regression optimization methods discussed above may alternatively be used in performing scatterometry on optical devices, such as PC/LED devices. In addition, although the results here relate to light intensity distributions, these same techniques may be performed by detecting or measuring phase or polarization of light, within the scope of the invention. It is also not necessary to change the angle of incidence of the light. If a multiple wavelength (e.g. spectral or white light) source is used, the angle of incidence may remain fixed, and measurements made using color intensity distributions, instead of a single wavelength intensity distribution.

The relatively simple photonic crystal structure shown in FIG. 7 has a regular doubly periodic array of round holes. A more optimized scattering structure can offer even further enhancements to the output efficiency of LEDs.

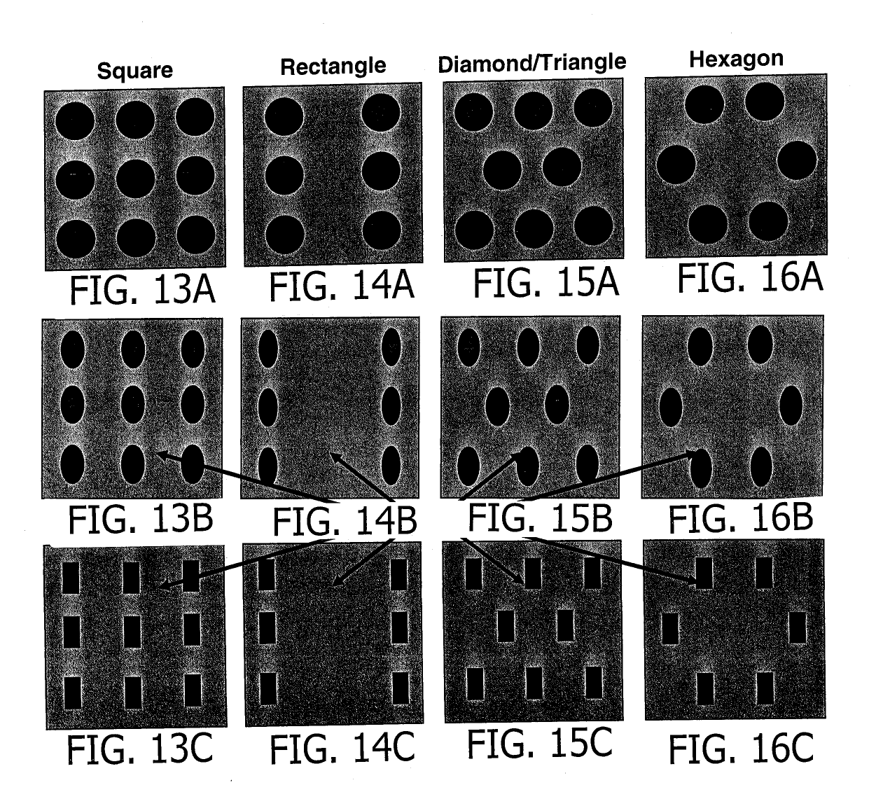

Various geometric designs can help optimize performance of the scattering PC structure. As shown in FIGS. 9, 13A, B and C, a square or other non-triangular array layout, or a hexagon array layout, as shown in FIGS. 16A, 16B and 16C, may be used. As used here, the word scattering feature or scattering structure means a structure or condition where there is a localized difference in refractive index relative to the host medium (with the host medium being air in the examples shown). Accordingly, while scattering features are generally described here as solid surfaces, scattering features may also take other forms.

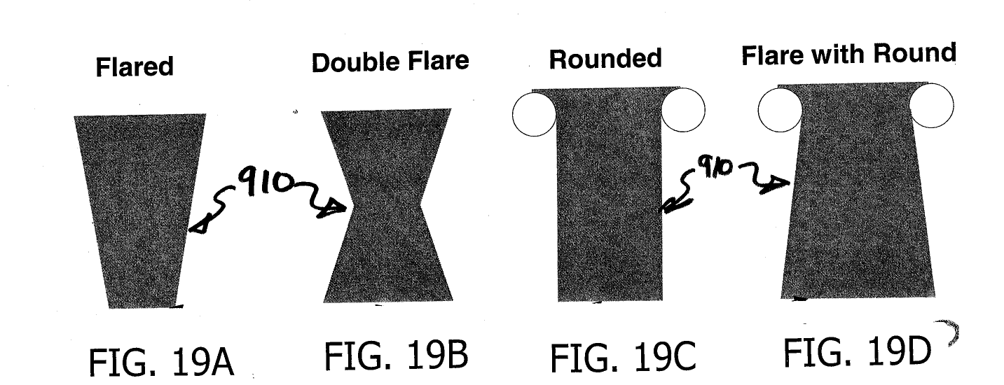

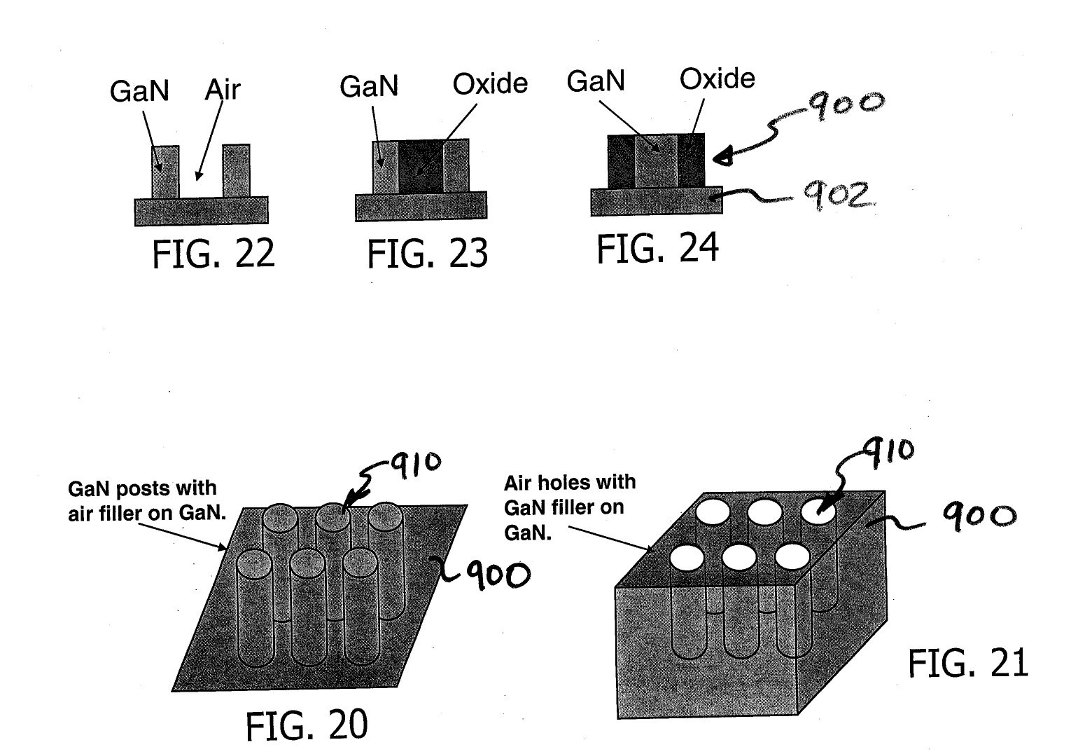

As shown in FIGS. 14A, 14B or 14C, a rectangular or non-symmetric array layout, and oval or elliptically shaped scattering features, as shown in FIGS. 13B, 14B, 15B or 16B may be used. Similarly, as shown in FIGS. 13C, 14C, 15C or 16C, the scattering features may be square or rectangular, or have other non-circular shapes. The scattering feature may also be flared or tapered, with a sidewall of the structure intentionally not vertical, as shown in FIG. 19A. Multiple tapers along the profile of the scattering feature may also be used, as shown in FIG. 19B. As shown in FIGS. 19C and D, the corners on the scattering feature can be radiused or rounded or chamfered (at either end of the feature).

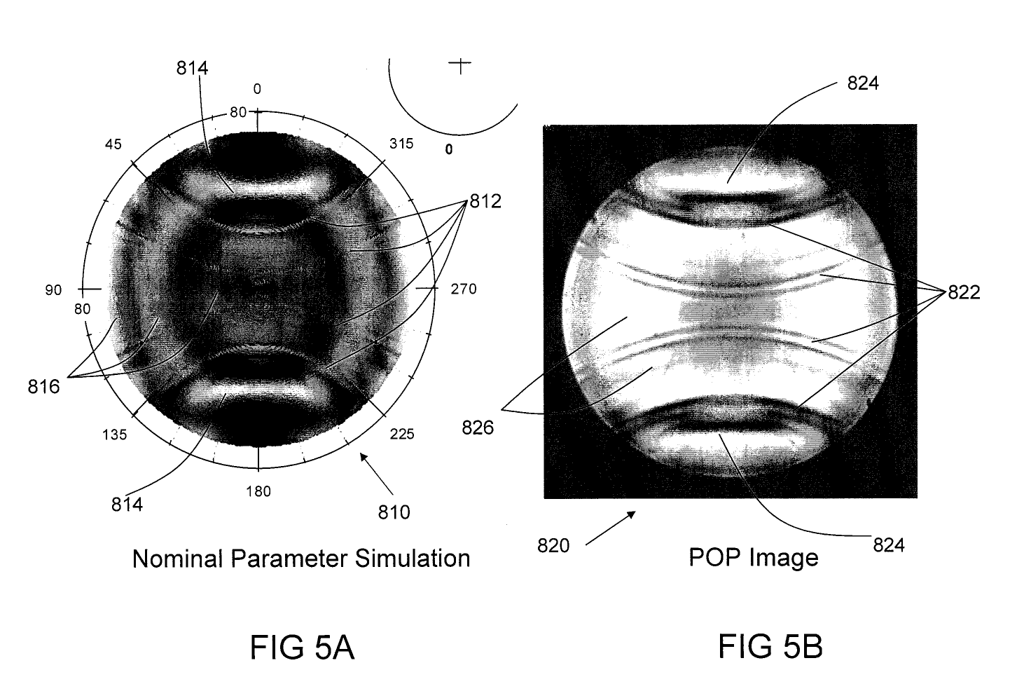

The scattering feature of the PC may be made of different materials. PCs typically use air as the scattering feature, as shown in FIGS. 21 and 22. In these designs, the holes are surrounded by a filler material. In the design shown in FIGS. 21 and 22, the filler material is GaN. The filler material may also be a metal, or an oxide, such as silicon oxide, silicon oxy-nitride, or silicon nitride. The filler material may also have a non-uniform index of refraction, such as a material with a graded index of refraction. The holes may also be replaced with (or filled with) a material, including any of the materials listed above, so long as the filler material and the hole material have sufficiently different indices of refraction. In these designs, where the scattering element and the surrounding or filler area are solid materials, there are no holes per se. Rather, the PC is formed with the scattering features (formed as rods, bars, etc.) surrounded by the filler material, as shown in FIGS. 23 and 24. In addition to GaN, other materials such as AlInGaP, AlInGaN, or GaAs may be used.

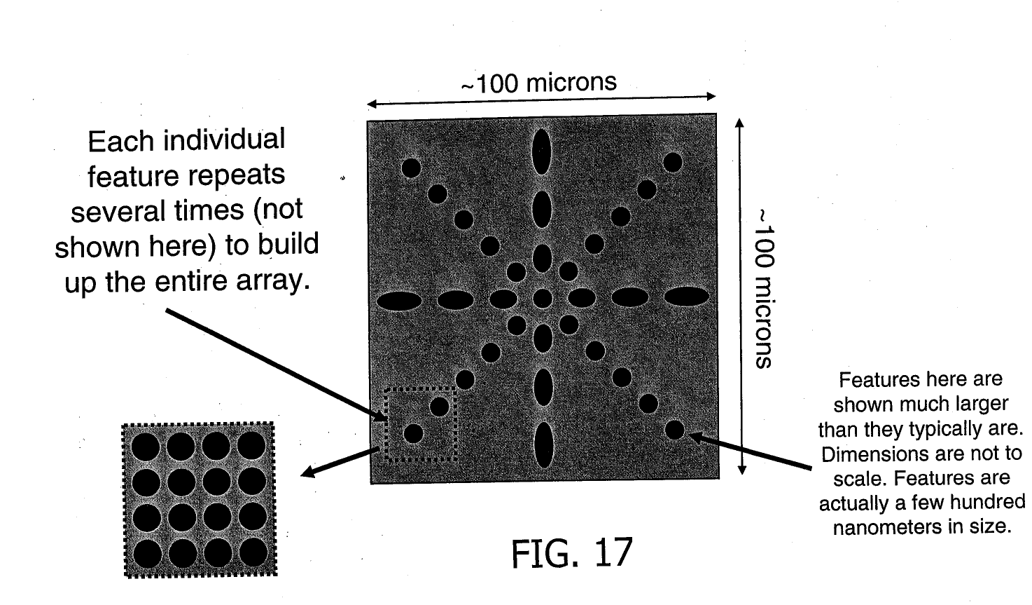

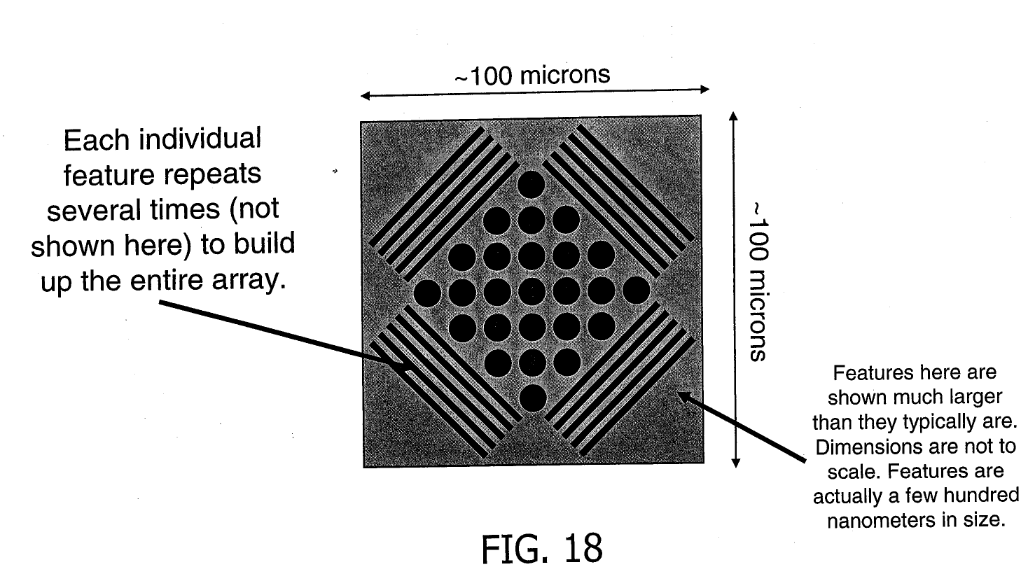

The geometries of the scattering features may vary across the array. For example, one application for optimal light extraction might require circular features near the center of the PC, with elliptical features near the edge, e.g., as shown in FIG. 17. Alternatively, patterns made via combinations of compact features (round, elliptical, square, rectangular, etc.), and elongated features (such as lines), as shown in FIG. 18, may be used. In some designs, the use of combined doubly-periodic (holes or posts) and singly-periodic (lines or spaces) as the scattering features, in the same array, may be advantageous.

These description above may also apply to other optical devices and synthetic optical structures, as well as to for example semiconductor laser diodes, holograms, synthetic lenses, optical filters, optical switches, waveguides and other devices. Similarly, the systems and methods described may be used with flat wafers, structured wafers, LED chips, photonic crystal chips, LED devices with photonic crystals on top, and fully packaged devices. The methods may also be used in optical modeling to simulate emission behaviors of an LED and photonic crystal combination.

From the foregoing, it will be appreciated that specific embodiments of the invention have been described herein for purposes of illustration, but that various modifications may be made without deviating from the spirit and scope of the invention. Accordingly, the invention is not limited except by the following claims and their equivalents.

1. A method for measuring a dimension or angle of a scattering feature of an optical element having an array of the scattering features comprising:
irradiating at least part of the array with light;
detecting a characteristic of light scattered from the array;
running a comparison algorithm on the detected characteristic of the scattered light; and
outputting one or more numerical values indicative of the measured dimension or angle, based on the result of the comparison algorithm.

2. The method of claim 1 wherein the scattering feature comprises a substantially transparent material.

3. The method of claim 1 wherein the scattering feature comprises a post or a hole.

4. Apparatus for measuring a dimension or an angle of a feature of an optical element comprising:
a light source;
optics for focusing light from the light source onto a target area of the optical element;
a light detector positioned to detect scattered light from the target area, with the detected light used to create a measured light characteristic;
a computer linked to the light detector, with the computer performing a comparison algorithm on the measured light characteristic and outputting a numerical value indicative of the dimension or angle measured.

5. An LED including a photonic crystal having an array of scattering features, with substantially each scattering feature comprising an opening through the photonic crystal, with the opening having single flare or double flare sidewalls.

6. The LED of claim 5 further including a rounded entry at one end of the opening.

7. An LED including a photonic crystal having an array of scattering features, with substantially each scattering feature comprising an opening through the photonic crystal, and with a rounded entry at one end of the opening.

8. An LED including a photonic crystal having an array of scattering features, with substantially each scattering feature comprising an opening through the photonic crystal, with the opening having an oval, elliptical, square, or rectangular cross section.

9. An LED including a photonic crystal having an array of scattering features, with substantially each scattering feature comprising a post formed of an optical material, and with the posts surrounded by a gaseous filler material.

10. The LED of claim 9, with at least some of the posts having single flare or double flared sidewalls.

11. The LED of claim 9 wherein the optical material comprises gallium nitride and the gaseous filler material comprises air.

12. The LED of claim 9 wherein the posts have a round, oval, elliptical, square, or rectangular cross section.

13. The LED of claim 9 wherein the array is in a square, rectangle, diamond or hexagon pattern.

14. A method for designing an optical element, comprising:
simulating an intended scattering response or pattern based on light emission characteristics desired from the optical element;
identifying one or more design parameters of the optical element;
varying the design parameters;
determining an interim scattering response of the optical element as the design parameters are varied;
comparing interim scattering responses to the intended scattering response;
selecting one or more interim scattering response matching the intended scattering response; and
using one or more of the design parameters associated with the selected interim scattering response in designing the optical element.

15. A method for measuring a dimension or angle of a scattering feature of an optical element having an array of the scattering features comprising:
irradiating at least part of the array with light at a range of incident angles;
detecting a distribution of light scattered from the array;
comparing the detected distribution of the scattered light to a database of simulated scatter distributions, with each simulated distribution having at least one associated numerical dimension or angle value;
selecting a simulated scattered distribution substantially matching the detected scattered distribution; and
providing the one or more numerical values associated with substantially matching simulated intensity distribution, as the measured value of the dimension or angle.

16. Apparatus for measuring a dimension or a feature of an optical element, comprising:
a light source;
optics for focusing light from the light source onto a target area of the photonic crystal;
a light detector positioned to detect light from the target area, with the detected light used to create a measured scattered radiation distribution;
a computer linked to the light detector, with the computer including a database of stored scattered radiation distributions corresponding to different sets of critical dimensions of one or more features of an optical element, and with the computer able to identify one or more stored scattered radiation distributions generally matching the measured scattered radiation distribution.

17. The method of claim 1 wherein the comparison algorithm operates by comparing the detected light characteristic to a database of simulated light characteristics, and selects one or more of the simulated light characteristics that most closely match the detected light characteristic.

18. The method of claim 17 wherein the detected light characteristic is intensity, phase, wavelength or polarization.

19. The method of claim 1 wherein the light is monochromatic, and further including changing the angle of incidence of the light.

20. The apparatus of claim 4 wherein the measured light characteristic is scattered radiation distribution and with computer including a database of stored scattered radiation distributions corresponding to different sets of dimensions of one or more features of an optical element, and with the comparison algorithm identifying one or more stored scattered radiation distributions generally matching the measured scattered radiation distribution.

21. The apparatus of claim 4 wherein the comparison algorithm comprises means for performing a regression optimization.

22. The method of claim 1, 14 or 15 wherein the optical element comprises a photonic crystal, a hologram, a synthetic lens, an optical filter, an optical switch, an optical waveguide or other synthetic optical structure.

23. The method of claim 1, 14 or 15 wherein the light is UV, visible, or IR light.

24. The apparatus of claim 4 wherein the light source and the light detector are positioned on opposite sides of the optical device, and the computer performs a comparison using transmissive characteristics.
